(19) United States
(12) Patent Application Publication
(10) Pub. No.: US 2025/0119450 A1
(43) Pub. Date: Apr. 10, 2025

(54) SYSTEM AND METHOD FOR ENHANCED ADVERSARIAL RED-TEAMING

(71) Applicant: The Research Foundation for the State University of New York, Albany, NY (US)

(72) Inventors: Gary Ackerman, Albany, NY (US); Brandon Behlendorf, Albany, NY (US); Douglas Clifford, Albany, NY (US); Kristian Wetzel, Albany, NY (US); Hayley Peterson, Albany, NY (US); Jenna Latourette, Albany, NY (US)

(21) Appl. No.: 18/895,902

(22) Filed: Sep. 25, 2024

Related U.S. Application Data
(60) Provisional application No. 63/540,499, filed on Sep. 26, 2023.

(51) Int. Cl. H04L 9/40; H04L 41/14; H04L 41/22; H04L 41/50

(52) U.S. Cl. CPC H04L 63/1433; H04L 41/145; H04L 41/22; H04L 41/5032

(57) ABSTRACT

A system and method for conducting enhanced Red Teaming simulations across a network that provides a distributed, predefined or randomly generated dataset for Red Team testing to one or more participants across the network, such as a security breach or other adversarial scenario. The scenario is either predetermined or can experimentally vary the parameters of the scenario. A user interface is provided to show the distributed scenario dataset to one or more participants such that structured data gathering can be done from participant input with empirical results data being generated. The scenario dataset for Red Team testing can be iteratively simulated with predetermined variations in the predefined data, and the number of participants can accordingly be scaled across the network as needed.

### CROSS-REFERENCE TO RELATED APPLICATIONS

The present application claims priority to U.S. provisional patent application, 63/540,499 “SYSTEM AND METHOD FOR ENHANCED ADVERSARIAL RED-TEAMING”, filed Sep. 26, 2023, which is hereby incorporated by reference.

### STATEMENT REGARDING FEDERALLY SPONSORED RESEARCH

This invention was made with government support under Grant Award Number 17STQAC00001-03-3, awarded by the Department of Homeland Security. The government has certain rights in the invention.

### BACKGROUND OF THE INVENTION

### 1. Field of the Invention

The present invention generally relates to systems and methods of computer modeling and simulation of strategic situations. More particularly, the present invention relates to a system and method for providing an enhanced model for tactical, operational and strategic Red Teaming that combines human interaction with a computerized template and data integration to produce a more thorough predictive data set for adversarial strategies and actions.

### 2. Description of the Related Art

A “Red Team” is an actor or group of actors that plays the role of an adversary in a strategic, tactical, or operational situation to provide feedback from an antagonist's perspective. “Red Teaming” is a simulation of adversary (or adversarial) decisions or behaviors, where outputs are measured and utilized for the purpose of informing or improving defensive capabilities and is widely used within the national security community to aid security and threat assessments. Red Teams are used in many fields, such as military wargaming, cybersecurity, facility hardening (e.g., airport security), law enforcement, and intelligence assessments. Red Teaming counters intrinsic cognitive biases and heuristics that distort decision-making and undermine effective planning and policymaking by providing novel perspectives, intentionally challenging existing plans, and improving understanding of the operational environment. Red Teaming is especially helpful for discovering previously unidentified vulnerabilities; robustness testing of existing defensive measures; exploring emerging but novel threats; and raising awareness of incipient security challenges.

Although widely implemented, Red Teaming (outside of the cybersecurity domain) has rarely, if ever, been conducted both systematically and at scale, substantially limiting the generalizability of its results. This undermines its credibility among many decision makers, who are understandably reluctant to shape policy around the results of a single (or even a small number of) simulations.

Detailed explorations of adversarial behavior, whether empirically coded or simulated, are of particular interest to operational agencies and many corporate contexts of competition. Comprehensive information on how adversaries may act aids planning efforts, especially in relation to the emergence of new offensive or competitive capabilities or technologies. Moreover, impact assessments of security or investment policies and practices often require the recording of behavioral data with and without the specific implementation. For novel policies, practices or technologies, data of this type can be scarce, and the lack of suitable validation data is often identified as a problem with extant risk models. Thus, methods are needed to investigate potential adversary behavior where empirical data is limited, challenging to obtain or even non-existent, while producing generalizable results that permit a robust impact assessment of interventions. For example, risk models that predict a certain deterrence efficacy for a new scanning technology at airport checkpoints cannot be a priori validated using existing approaches (such as a testing dataset) given the fact that the technology has never been implemented before and thus there is no empirical record against which to assess the deterrent impact of the technology on adversaries). Given the highly dynamic nature of threats against air transportation and the completely novel technology under consideration, using proxy data on prior roll-outs of different technologies would not provide a sufficient test or validation of the impacts of the new system.

What is required, therefore, is a means of validating adaptive adversary models that does not rely on a trove of empirical data that might be inaccessible or irrelevant due to a highly dynamic threat context. Finding a dependable method of validating tactical,—operational or strategic-level adversary behavior models, which can incorporate changing adversary threats, countermeasures and other operational circumstances, would thus substantially increase the value of existing risk assessment efforts, especially in highly dynamic threat or competitive environments.

### BRIEF SUMMARY OF THE INVENTION

Briefly described, the present system and method is an automated tool for translating tactical, strategic-or operational-level Red-Teaming into a scalable, replicable research and analytical methodology, thus significantly enhancing the capabilities of current Red Teaming practice. The system is called DESSRT (Distributed, Empirical, Systematic, and Scalable Red Teaming). Like in many types of scenario-based Red Teaming, DESSRT participants adopt adversary roles and then plan a simulated attack or other adversarial action such as the launch of a competitor product into a marketplace. Unlike traditional, shorter survey instruments, participants are provided extensive background on the adversary or adversaries they have been assigned and primed (through a series of debiasing exercises) to role play adversary (Red) decisions under the given input conditions. Granular information regarding courses of action (such as target selection or tactic employed) is captured. In addition, the tool—crucially—captures the reasoning behind why those options are selected, as well as the reasons why other options were initially considered and then rejected. DESSRT can also be combined with other methodologies, including: a) choice experiments and haptic measurements, in order to more robustly examine the dynamics of adversary decision-making, as well as b) drawing on a variety of other technologies, including virtual reality and machine learning, in order to create more granular or immersive simulation environments. under different.

At its core, the DESSRT framework consists of four advances on existing Red Teaming methodologies, which when combined improve both the fidelity of the findings generated and their generalizability.

A) The framework leverages distributed technologies to expand Red Team participation beyond the typical conference room, or tabletop, venue. Although not completely new to Red Teaming, previous distributed exercises have focused on collaboration via virtual sessions enabled by web conferencing technologies, such as Microsoft Teams or Zoom. The DESSRT framework moves beyond simultaneous collaboration to leverage asynchronous capabilities that allow remote individuals to participate at a time of their choosing and at their own pace. This expands the opportunity for Red Teaming exercises to diversify perspectives and avoid potential biases by including globally-located participants and/or individuals whose availability falls outside regular business hours in a single time zone.

B) The framework promotes systematic approaches to Red-Teaming. One of the benefits of Red-Teaming generally that many other modeling or analytical approaches lack, is its ability to rapidly incorporate flexible inputs from participants to encourage creative, exploratory thinking about threats. Yet this can lead to open-ended inputs and unstructured data that is difficult to compare across multiple iterations. The DESSRT framework, which places emphasis on the replicability of findings, standardizes data collection methods while minimizing constraints on participant creativity. Thus, while allowing for open-ended inputs necessary for qualitative assessment, the DESSRT framework requires more structured participant deliberations (whether at the individual or group level). These can include standardizing instructions and data input requests, requiring follow-up questions to initial inputs, and constructing similar experiential requirements across iterations (e.g., the amount of time spent on a particular portion of the scenario). As part of the use of the tool, simulation designers are required to create partial ‘scripts’ for the overall sequence of experiences as well as the format of scenario prompts and participant inputs, thus moving Red Teaming from a relatively open-ended exercise format to a more structured assessment framework.

C) The systematic nature of the framework allows for the generation of useful empirical data from the participants in the Red Teaming simulation. Standardizing the simulation instrument, incorporating structured sequences of interaction, and allowing for integration with other research methods (such as survey experiments) expands the empirical research opportunities regarding adversarial decision-making processes and adaptations. While most Red Teaming exercises by their nature generate simulated data (as opposed to real-world observations), DESSRT simulations generate systematic observations of human behavior in an experiential or experimental setting. These qualities allow for DESSRT outputs to constitute usable empirical data, following generally accepted definitions of the term as information that “originat[es] in or [is] based on observation or experience” or “information that is acquired by observation or experimentation”. This in turn enables advanced data analytic approaches to be applied.

D) The DESSRT framework allows for scalable Red Teaming, where human decisions in a simulated environment are consistently repeated across multiple iterations and participants. Red Teaming is typically employed in one-off fashion, often when prompted by a gathering crisis or emerging threat. The marginal cost of conducting additional iterations of a simulation has traditionally been quite high, as most if not all the logistics involved with conducting the initial simulation must be repeated. Focused on systematizing and distributing the Red Teaming format, the DESSRT framework reduces the marginal cost of additional iterations, thus making it highly scalable. Each simulation itself can be easily iterated dozens and even hundreds of times, allowing for replicability of findings and the experimental manipulation of one or more factors (input variables) in the simulation. A Red Teaming simulation can also be scaled across teams or units, allowing for multiple institutional as well as individual perspectives regarding vulnerabilities or other concerns for the problem at hand.

In one embodiment, the DESSRT system for conducting enhanced Red Teaming exercises is instantiated across a network using a computer platform that has: 1) a simulation module that iteratively simulates the specific scenario using predetermined variations in experimental conditions or predefined data; 2) a distribution module for providing the generated initial conditions and scenario parameters, as well as background context information, debiasing tools and data “injects” (scenario artifacts that can be textual, audio, video, etc.) for Red Team testing to multiple participants across a network, 3) an input module that provides a user interface for structured data gathering from participant input, 4) a module for managing and responding to participant input in a dynamic manner (e.g., presenting specific injects randomly or responding to particular inputs with rule-based follow-on scenario branches), 5) a method of systematically capturing and storing all scenario interaction, randomization and input data, and in some cases, 6) an ability to perform basic analytical tasks and generating empirical results directly from the inputted data.

The distribution module can be embodied to provide the predefined dataset for Red Team simulation and testing to multiple participants asynchronously. The system can be configured to automatically select which iteration of the simulation participants receive either randomly or based on the specific expertise, knowledge or experience of the participant. The input module can be further embodied to provide a wide range of both standardized and unstructured inputs in the user interface and can also selectively request further input from participants.

Depending on the objectives of the Red Teaming, the number of factors that require variation and breadth of decision data desired, the DESSRT tool is inherently scalable from a single participant up to hundreds or even thousands of participants in the Red Teaming. The asynchronous nature of the simulations mean that network bandwidth is not a concern even for simulations that involve large virtual environments, since participants do not all access the same parts of the simulation at the same time. The only limitations on scale are usually the resources required for identification, recruitment and compensation of participants, where these are necessary (in many cases, such as testing within an organization, these limitations do not exist). However, these limitations exist outside of the DESSRT tool. The tool also allows for the straightforward increase in scale during a simulation, for instance if a greater diversity of participants is desired or the sample needs to be increased to obtain statistically significant analyses.

The present invention therefore provides an advantage in providing a reliable, scalable, and iterative Red Team analysis of a given decision problem scenario, real or hypothetical. The present system and method have industrial applicability in providing an automated computer system to standardize context-setting, injects, questioning and input from Red Team participants, which can be dynamically scaled or have the scenario altered to generate better data. These and other advantages and applications of the present invention would be apparent to one of skill in the art.

### BRIEF DESCRIPTION OF THE DRAWINGS

FIG. 1 is a diagram of the present system architected in a cloud computing system.

FIG. 2 is an object diagram for one embodiment of the system component objects.

FIG. 3 is a diagram of part of the game theory model representing one embodiment of the system.

FIG. 4 is a mathematical description of the game theory model of FIG. 3.

FIG. 5 is an exemplary chart of the weapon complexity, subversion complexity and subversion method models generated in one embodiment of the system.

FIG. 6 is a graph of the frequency of trigger mechanism selected by participants in an exemplary enhanced Red Teaming exercise administered by the present system.

FIG. 7 is a chart of sample model outputs compared with system outputs for one embodiment of the system.

FIG. 8 is a chart of sample model outputs compared with system inputs for one embodiment of the system.

### DETAILED DESCRIPTION OF THE INVENTION

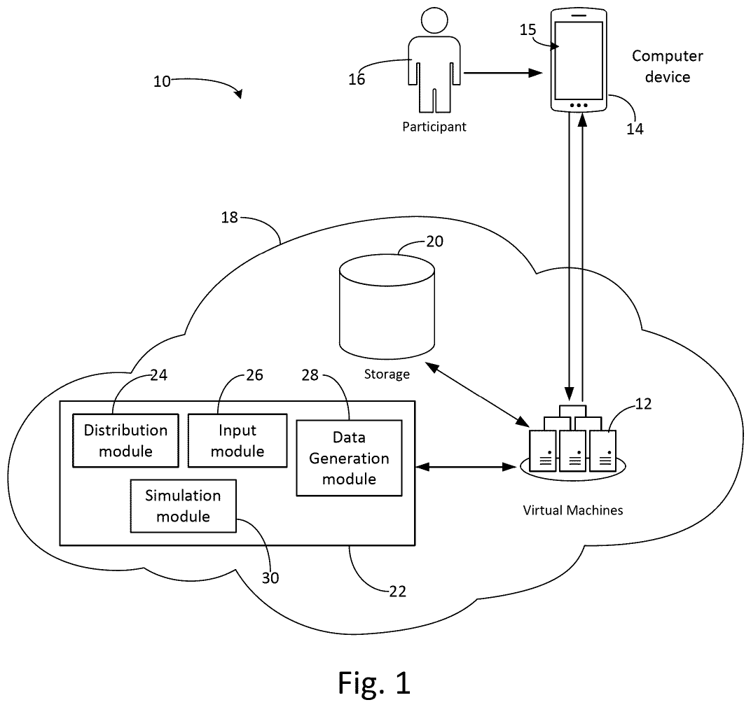

With reference to the figures in which like numerals represent like elements throughout the several views, FIG. 1 is a diagram of the present system 10 architected in a cloud computing system. The system 10 for conducting enhanced Red Teaming exercises across a network, such as the Internet 18 includes a virtual computer platform 22 that is located on virtual machines 12 in the cloud (Internet 18). The virtual machines 12 are also in communication with one or more data stores 20 for holding the data related to the Red Team exercise. The computer platform is configured to provide a distribution module 24 for providing a scenario containing a set of data (scenario, parameters, roles, etc.) to one or more participants 16 across the network 18. The participant 16 will interact with a computer device (e.g., mobile phone, personal computer) 14 that sends and receives data from the virtual machines 12.

On the computer platform 22 there is also a simulation module 30 that iteratively simulates the specific scenario using predetermined or randomized variations in experimental conditions or predefined data for Red Team testing, the iterative simulation being sent as a predefined dataset to the participant(s) 16 across the network 18 via the distribution module 24. In addition, there is an input module 26 that provides a user interface 15 for both structured and unstructured data gathering from participant 16 input, the input module 26 provided to one or more participants 16 through the distribution module 24, the input module 26 further selectively receiving participant data from the network (Internet 18), in one embodiment sent via virtual machines 12. The is also on the computer platform 22 a data collection and analysis module 28 for storing, organizing and generating empirical results data from the participant 16 data gathered from the input module 26.

In one embodiment, the distribution module 24 is further configured to provide the predefined dataset for Red Team testing one or more participants asynchronously, such that the participant 16 can respond to the Red Team simulation at the time and place that the participant desires to do so. This allows flexibility in having a large participant 16 pool available as they are not time-constrained or geographically limited in their interactions with the system 10 and their responses.

Further, the input module 26 can provide at least one standardized input (and usually at least several dozen inputs) in the user interface 15, for the participant 16 to interact with, thus normalizing data input from the participants into a common format. The input module 26 can be embodied to selectively request further input from the one or more participants 16, such as follow-up questions or scenario prompts, or as part of a dataset change in a simulation.

The data generation module 28 can be embodied as integrating one or more external datasets with the gathered participant data, such as other testing data, standardized data, or a real-world example. The data generation module can also then further integrate the one or more external dataset with the input module 26, and the input module 26 further selectively requests further input from the one or more participants 16 based upon the one or more external dataset. The simulation module 30 can also further selectively alters the number of the one or more participants 16 for the predefined data set for red-team testing.

Although Red Teaming overlaps to some extent with several related activities, such as wargaming, alternative analysis and risk assessment, it is not identical to any of them. For example, it shares with wargaming the presence of an adversary and other attributes such as a degree of uncertainty (i.e., outcomes are not wholly predetermined) but Red Teaming is not limited to battlefield simulation and an evaluation of outputs but does not insist upon some of the structured action or adjudication elements of traditional wargaming. So, while all wargaming is in a sense Red Teaming, not all Red Teaming is wargaming. In a similar vein, Red Teaming emphasizes the reduction of cognitive and other biases and the challenging of existing assumptions through improved critical thinking, but its insistence on adopting an adversarial point of view distinguishes it from the broader practice of alternative analysis. Last, while Red Teaming does not by itself constitute a risk assessment or forecast in the sense of directly outputting prescriptions, it can both leverage as inputs and feed into these types of analysis.

Red Teaming encompasses a variety of structured activities, ranging from field exercises, and computational simulations, to cyber penetration testing and tabletop exercises, and can therefore be regarded as more of a toolkit with a shared emphasis on the core elements of simulation and adversarial perspectives than a single technique. Red Teaming can also be leveraged to perform several essential functions in the security domain, including: discovering previously unidentified vulnerabilities in defensive systems to test (even sometimes “stress test”) whether the operation of existing defensive measures or plans are robust against a variety of adversaries and attack. It can also be used to gain insight into emerging threats, and to raise awareness of extant and incipient challenges in any competitive context, including business and litigation. Red Teaming can further be used as a training tool for those responsible for preventing or responding to threats or competitive challenges. In the aviation security sector, for example, Red Teaming is widely used in the form of field penetration testing for the purposes of raising awareness, testing defenses and training personnel, while it has also been used to identify emerging threats.

At its root, the practice of Red Teaming is fundamentally focused on simulating adversary behavior. Even though it is usually recognized by its practitioners that non-adversary participants might not behave exactly the same as real-world attackers in all circumstances, implicit in the use of Red Teaming for purposes such as identifying vulnerabilities, training personnel and exercising response protocols is the assumption that participants can serve as “good enough” proxies. For example, even if a set of opposing force (OPFOR) Red Teamers might not breach a facility fence in the same spot as actual terrorists, their unexpected and creative activities would still be sufficient to test the alertness of facility guards.

Given Red Teaming's foundational focus on simulating adversary behavior, one key novel application of DESSRT is in utilizing Red Teaming as a solution to the problem of validating adversary models that lack empirical referents., is as This is important because lack of adequate validation means that decision-makers often are forced to base their decisions on models that cannot be validated beyond “face validation” (in other words, having the model's outputs reviewed by experts for their reasonableness or plausibility). Yet, Red Teaming, which previously has not been capable of being conducted systematically and at scale, has not previously been applied specifically for the purpose of validating adversarial models. The DESSRT system for the first time offers the capability to accomplish such validation through the use of structured, scalable Red Teaming.

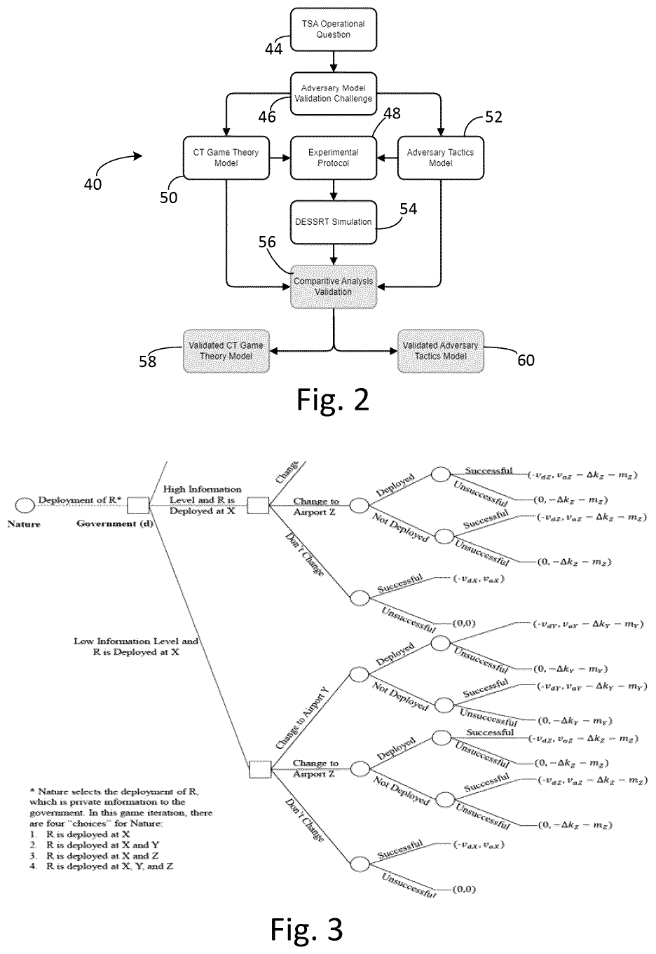

FIG. 2 is an object diagram 40 for one embodiment of the system component objects. In this embodiment, a validation framework for adaptive adversary models, the project takes an experimental approach, utilizing a common set of input parameters derived from real-world historical cases and comparing outputs from two types of adaptive adversary models (as an illustration we use an adversary tactical choice model and a game theory model) with those from two different sets of proxy human decision-makers (such as participant 16; FIG. 1), in this case simulating terrorists planning to attack an airport.

The DESSRT framework can be demonstrated within the context of aviation security, evaluating how simulated adversaries select operational modalities and how they would respond to governmental information disclosures about new planned security measures. Specifically, in this exemplary case, the design consists of an operational Transportation Security Administration (TSA) question object 44 about terrorist tactics at airport checkpoints.

An adversarial model validation challenge object 46 is created to address the operational question 44 by development of a series of theoretical adversary tactical choice models. This is then transformed into an experimental protocol object 48 that sets up a simulation design to replicate the structure of the theoretical model inputs and outputs and forms the basis of the DESSRT simulation. This allows the Red Teaming system to validate the adversary models, game theory object model 50 and adversary tactics model 52.

In this embodiment, the system 40 is depicted as validating two types of adaptive adversary models: utility models that predict tactical behavior of an adversary (adversary tactics model 52) with respect to attempts to move an explosive through airport security checkpoints 56 and a game theory model that predicts the impact of counterterrorism measures on terrorist behavior (Ct game theory model 50).

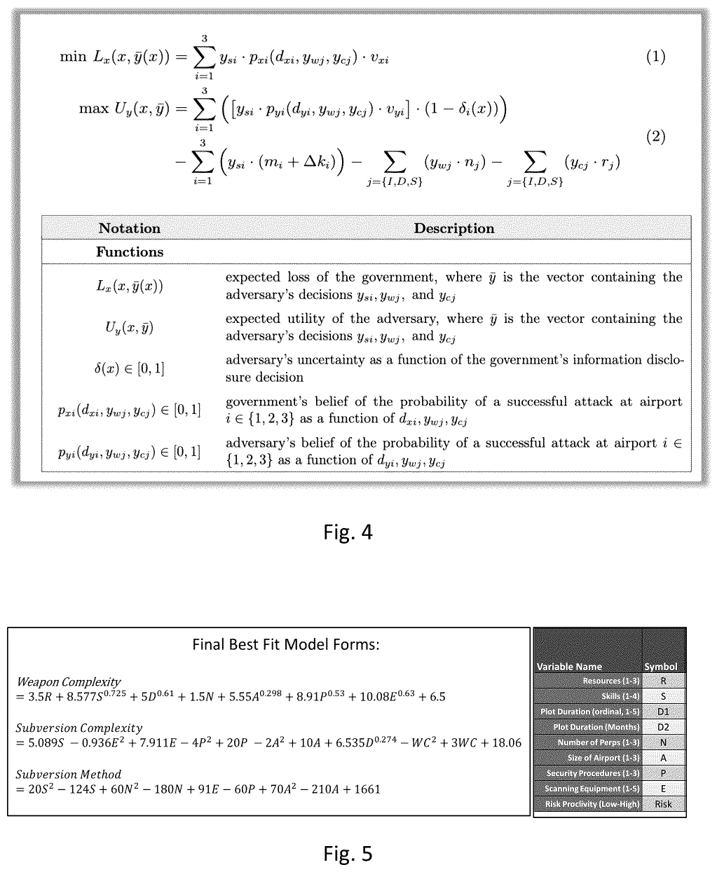

The tactical utility models in this embodiment examine the level of complexity of the weapon selected by the adversary (Weapon Complexity—WC), the level of complexity of the means that the adversary will try to subvert security measures (Subversion Complexity—SC) and the method that the adversary will utilize to conduct the subversion (Subversion Method—SM). The equations of FIG. 4 and descriptors of FIG. 5 represent one example of a Weapon Complexity (WC), Subversion Complexity (SC) and Subversion Method (SM) model, which is not intended as a limitation. In this example, the WC, SC and SM models include, among others, such inputs as the level of security procedures at the airport (P), and the skills (S) and resources (R) of the attacker.

The development of a game-theoretic counterterrorism model object 50 allows the assessment of adversary behavior when confronted with different information regarding the deployment of CT measures. This is based on the hypothesis that modifications in security installations can influence adversary behavior in one of two ways: 1) information about where the new security measures are deployed influences the adversary's perceived likelihood of apprehension; and 2) the depth of information about the security measures influences the adversary's level of uncertainty about the effectiveness of the security measure (and affects their perceived likelihood of success). In this example, the specific focus is the installation of new CT scanners in airport passenger screening, and whether the simulated adversary would have access to limited or detailed information about the scanning technology.

In this embodiment, the key elements of the model look at whether the adversary shifts its target airport, whether the adversary changes weapon complexity, and whether the adversary changes subversion complexity in response to different levels and types of information about new computed tomography (CT) scanners. One example of part of a game theory model that can be used for object 50 is partially depicted in the diagrams of FIG. 3 and FIG. 4. The diagram employs the following equations for determination of optimal outcomes, which are simple embodiments of the model and not intended as limitations:

$$min {L}_{x} ( x , \overline{y} ( x ) ) = {\sum }_{i = 1}^{3} {y}_{si} \cdot {p}_{xi} ( {d}_{xi} , {y}_{wj} , {y}_{cj} ) \cdot {v}_{xi} \\ max {U}_{y} ( x , \overline{y} ) = {\sum }_{i = 1}^{3} ( [ {y}_{si} \cdot {p}_{yi} ( {d}_{yi} , {y}_{wj} , {y}_{cj} ) \cdot {v}_{yi} ] \cdot {δ}_{i} ( x ) ) - {\sum }_{i = 1}^{3} ( {y}_{si} \cdot ( {m}_{i} + Δ {k}_{i} ) ) - {\sum }_{j = \{ I , D , S \}} ( ( {y}_{wj} \cdot {n}_{j} ) + ( {y}_{cj} \cdot {r}_{j} ) )$$

To validate the models discussed above 50,52 an experiment is then created that incorporates the various inputs of the model (such as the abovementioned attacker skills, resources, and the specificity of information about CT scanner deployment) and structures the outputs of experiment in terms of the model outputs (including, in this embodiment, the complexity of the weapon and shifts in target choice). This is reflected in an experiment protocol 48, which randomly assigns one of three different adversaries to participants (each having a different set of input values), as well as randomly assigning treatments according to different levels of information conveyed about CT scanner deployment. As outputs, the experiment collects several operational choices about the weapon (trigger, housing, explosive used, etc.), which can be translated into weapon complexity, as well as any changes in attack decisions following the inject of the CT scanner information (including whether the attacker changes target airports).

The DESSRT approach (DESSRT simulation module 54) is structured in this example as a two-phase simulation of adversary decision-making (given the title Operation Chameleon Fire), with an experimental inject (information about CT scanners) provided between the two phases. The activities undertaken by participants during the simulation are divided into four sequential segments: 1) Preliminary Activities; 2) Phase 1 Attack Planning; 3) Inject; 4) Phase 2 Attack Planning; and 5) Debrief.

The DESSRT experimental process is implemented in this embodiment through the recruitment of two cohort samples—an expert sample made up of process security personnel, and a naïve (non-expert) sample made up of college students. Overall, each participant 16 was required to input at least 470 distinct pieces of information (data points) during the simulation (which ran approximately 8 hours). Given the complexity of the exercise design, and the length of time needed to complete all phases, participants 16 were allowed up to two weeks from their starting date to complete the exercise. As an asynchronous, individualized process, participants were able to sign in and sign out of the system via a unique code, allowing respondents from multiple geographic areas to complete the exercise.

The DESSRT simulation module 54 randomly assigned participants to one of three attackers, varying in attributes such as resource levels, number of attackers, access to weapons expertise and ideology. Simulated airports with different levels of security along various dimensions (such as security cameras), were also created. The simulation module 30 incorporated profiles om each adversary, as well as background information, terminal schematics, and additional reconnaissance information for each airport. The distribution module 24 then sent to each participant 16 sets of instructions for accessing the simulation interface 15 on the virtual machines on which the simulation resided 12.

Upon launching the simulation 15 on their device 14, participants 16 completed a short demographic survey, a series of awareness exercises regarding potential cognitive biases prevalent in Red Teaming, and a Cognitive Reflection Test to capture potential differences in decision-making processes between respondents. All data was collected by the input module 26.

The distribution module 24 then provided to each participant 16 their assigned role, as well as the accompanying packet of materials (role description, simulated airport information, etc.). Participants 16 were then prompted by the interface to engage in a structured process for planning an attack on their assigned aviation target (i.e., airport).

For the “initial attack planning” phase, participants 16 completed three 30-minute planning sessions, each coupled with an untimed journal entry (written in the first person from the perspective of their assigned perpetrator) to document their planning processes, information sources consulted and the status of their plot. Each session included note-taking space, asked respondents to list the top 10 websites that were most important for planning during that session and presented questions on planning progress in three areas: explosive, weapon package, and circumvention efforts. Individuals were allowed to access the outside internet to aid in their planning.

For the “attack plan,” participants were then asked to provide an overview of their attack plan (300-500 words), detailed information on key dimensions of operational significance and their justification both for these choices and for their rejection of other options considered, including Weapon Consideration and Selection. First, participants 16 identified all the explosive types they considered for use, the specific explosive type(s) they ultimately selected as well as the amount of explosive(s) selected. Second, participants 16 recorded all the different weapon package combinations (explosive, trigger, detonator, power source, and housing) they considered for their attack, as well as those selected. Concerning assembly, participants described how they assembled the weapon, including any deviations or new expectations from additional knowledge gained during planning efforts. Finally, participants 16 were asked for their reasoning in selecting both the specific explosive and weapon packages. The participant 16 was then asked to engage in “Circumvention/Security Subversion Consideration and Selection.” Since the exercise required conveyance of the weapon through passenger screening, participants had to consider their process for circumventing, subverting, or deceiving airport security measures. Scenarios provided to participants contained information on airport security measures equivalent to that which could be extracted via repeated reconnaissance visits to public areas of the airport. Using that information, participants were required to identify all considered options to circumvent, evade, or otherwise subvert airport security installations, as well as the selection and reasoning for their final selection of subversion method(s). All data was captured and stored by the input module 26 and could be utilized by the analytic module (Comparative analysis validation 56) to determine weapon complexity levels.

Once initial attack planning was completed, participants 16 were randomly assigned one of three injects providing different distinct levels of information on a new screening method (CT scanning equipment) that could be disclosed by the government regarding the deployment and efficacy of CT scanners. This included some receiving information that was less specific, for example (two sentences) on CT scanning equipment included among several unrelated pieces of aviation-related information (which functioned as “noise”), while others, for example, received more specific information (about two pages) about the installation of new CT scanning equipment modeled on an actual Transportation Security Administration (TSA) press release about CT scanning capabilities. Random assignments of information were balanced across assigned adversary/scenario and experimental treatments to ensure equivalent sample sizes in each scenario-treatment combination. In addition, participants were given the option to change their targeted airport in Phase II, with additional briefing materials provided for all three of the simulated airports.

The participants 16 then engaged in two subsequent planning sessions of 30 minutes each, coupled with journal entries, similar to those previously conducted. Participants were provided with their original attack plan, and then after completion of the planning sessions were asked whether they chose to modify their target, their choice of explosive, weapon package or security subversion technique. The simulation outputs are analyzed to extract a range of operationally-relevant results relating to adversary tactical choice, including such factors as choice of explosive, the reasoning behind subversion method selection, acquisition of weapon materials and so forth. In the sample embodiment, 178 participants took part in the simulation, with all data being collected by the input module 26. Several variables were directly quantitative or categorical in nature, which allowed for direct analysis by the Comparitive Analysis Validation module 56, which incorporates basic statistical analysis. For some free-text, qualitative fields (specifically the reasoning fields), a team of project coders reviewed each of the reasons provided by participants and inductively determined a coding schema for specific reasons. Standard methods for testing the presence of statistically-significant differences between observed and expected frequencies (chi-square tests) and two proportions (Z-test) were used. These and other free-text fields were also analyzed qualitatively to identify specific themes associated with adversary decision-making that emerged from participant inputs.

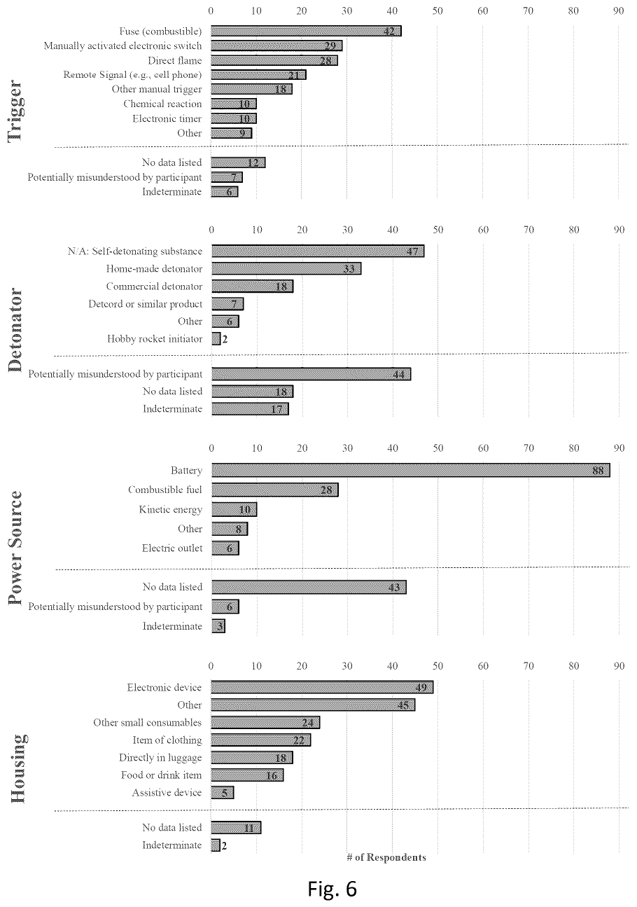

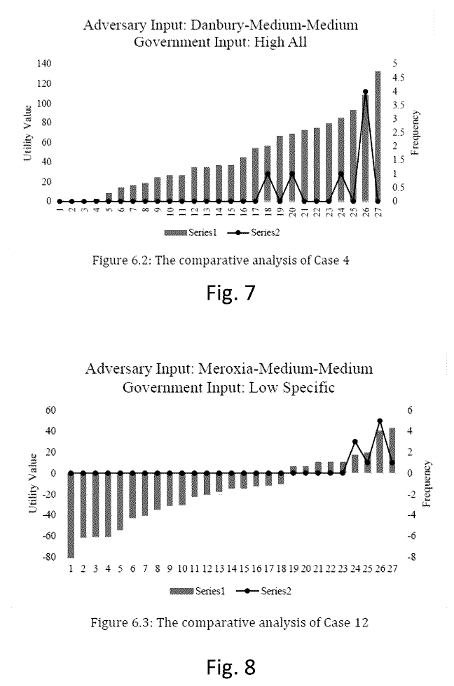

To demonstrate the efficacy of the DESSRT framework with respect to yielding improved Red Teaming results, an illustrative sample of three types of operational results can be provided. First, the DESSRT simulation provided a sufficiently large sample to examine the relative frequencies of potential adversary choices across various tactical decisions. For example, FIG. 6 is a graph showing the frequency of trigger mechanism, power source and housing selected by the participants 16. As FIG. 6 reveals, the simulation was able to provide fine-grained tactical details about the choice of weapon components, in this example trigger mechanisms, where combustible fuses were preferred more often than electronic switches, direct flames, or remote signals. As operational findings, results from the DESSRT approach can thus prove useful to practitioners who need to prioritize training, screening procedures and security measures against specific threat vectors.

Secondly, the DESSRT approach revealed significant variation in tactical decision making across the assigned adversary. For example, when it came to how participants sought to subvert existing security measures, significant differences were found across the three adversaries for tampering with screening devices (x2=10.27, df=2, p<0.01), opting out of the scanning process (x2=28.50, df=2, p<0.01), and bypassing the screening/scanner altogether (x2=9.47, df=2, p<0.01). Specifically, those assigned the unaffiliated adversary (an idiosyncratic lone actor) were more likely to select methods that opt-out or bypass specific screening requirements when compared to those assigned the other two (well-resourced) adversaries.

Thirdly, the simulation demonstrates that information about CT scanners had differential effects on adversary adaptation in Phase II of the exercise. The majority of participants (53%) changed one or more of the four key tactical decision areas (target; explosive; weapon package; subversion technique), which did not vary appreciably across treatment. For example, although there was some variation in the proportion of participants that changed their targeted airport, ranging between 17% for the high-specific information (HS) treatment to 21% for the high value information (HA) supplementation treatment, this difference was not statistically significant (x2=0.229, df=2, p=0.89). Although target change was not substantively different across treatment, those who changed primarily did so because the security was perceived as less robust at the new airport they were targeting (25/27 participants). Perceived security posture could be a product of numerous factors, so participants were asked in a follow-up question if the additional information on CT scanning was important in their decision-making. Of the 27 participants who changed targets, 18 reported (67%) that the additional information on CT scanners did have some effect on their target change decision. Although statistically non-significant (due to sample size limitations), those changing targets who received the HA treatment (detailed information on the technology, as well as that it was deployed at all airports) were most likely (80%) to report that CT information influenced their decision. Conversely, those receiving the HS treatment (detailed information but only certain that it was deployed at their specific airport) were the least likely treatment group (50%) to report CT information influenced their decision. While not conclusive, coupled with the consistency in change proportions across treatments, these findings imply that the level of information about CT scanners was less relevant for target change than other factors. Table 4 summarizes these quantitative results.

TABLE 4

| | Treatment Received | | | | | |
|---|---|---|---|---|---|---|
| | High All | High Specific | Low Specific | Total | Total | |
| Reported Changes | (n = 48) | (n = 47) | (n = 48) | (n = 143) | Statistic | p-val |
| Changed Airport | 21% | 17% | 19% | 19% | x² = 0.23 | 0.89 |
| | | | | | df = 2 | |
| Treatment information | 80%* | 50%* | 67%* | 67%* | x² = 1.80 | 0.41 |
| influenced decision | | | | | df = 2 | |
| Changed Weapon | 33% | 19% | 17% | 23% | x² = 4.36 | 0.11 |
| Selection | | | | | df = 2 | |

| | | | | |
|---|---|---|---|---|
| Pooled HS + LS Samples | 33% | 18% | x² = 4.28 | 0.04 |

In addition to the operationally-relevant results, the embodiment illustrates how the DESSRT framework can be utilized to validate adaptive adversary models. First, with respect to the tactical utility models, the outputs of the simulation (Operation Chameleon Fire—OCF) could be compared to the outputs of the model, given the same inputs. Table 5 shows the model outputs (single value) and DESSRT simulation outputs (distribution across respondents who were assigned each particular case) in the second and third columns, respectively. The fourth column calculates how many standard deviations from the mean of the simulation outputs, the model output lies. As can be seen from the table, the Weapon Complexity model output across all three simulated adversaries lies close to the mean of the decisions made by the human simulation participants. The Subversion Complexity model outputs lie further from the mean of the DESSRT outputs, but still within one standard deviation, whereas the Subversion Method model outputs are more than one standard deviation from the DESSRT outputs for two of the three adversaries. From a validation perspective, this indicates that greater credibility can be placed on the Weapon Complexity model, the Subversion Complexity Model as an adequate representation of human behavior but probably needs some tweaking, whereas the Subversion Complexity model likely requires substantial additional development. While not shown here, these models have been compared against actual historical cases, with equivalent results regarding model accuracy.

TABLE 5

| | | | |
|---|---|---|---|
| | | OCF Output | Model & OCF |
| | | (Mean; S.D. All | (# of S.D.s from |
| | Model Output | Respondents; | OCF Mean for |
| Model and Case | (Linear Model) | Basic Coding) | Model Output) |

Weapon Complexity

| | | | | |
|---|---|---|---|---|
| A | Daallo/ | 2.21 | 2.08 (0.6) | 0.2 |
| | Danbury | | [1.5-2.6] | |
| | Manchester/ | 1.83 | 1.72 (0.64) | 0.2 |
| | Meroxia | | [1.1-2.4] | |
| | Schiphol/ | 2.37 | 2.1 (0.66) | 0.4 |
| | Studebaker | | [1.4-2.8] | |

Subversion Complexity

| | | | | |
|---|---|---|---|---|
| B | Daallo/ | 1.94 | 2.47 (0.59) | 0.9 |
| | Danbury | | [1.9-3] | |
| | Manchester/ | 1.82 | 2.17 (0.56) | 0.6 |
| | Meroxia | | [1.6-2.7] | |
| | Schiphol/ | 2.74 | 2.28 (0.57) | 0.8 |
| | Studebaker | | [1.7-2.9] | |

Subversion Method

| | | | | |
|---|---|---|---|---|
| C | Daallo/ | 51% | 19% | 0.7 |
| | Danbury | (Probability of | 1.19 (0.4) | |
| | | Circumvention) | [0.8-1.6] | |
| | Manchester/ | 51.4% | 8.3% | 1.4 |
| | Meroxia | | 1.08 (0.28) | |
| | | | [0.8-1.4] | |
| | Schiphol/ | 49.93% | 11.5% | 1.2 |
| | Studebaker | | 1.12 (0.32) | |
| | | | [0.8-1.4] | |

A Rows = <0.5 SD from mean; B Rows = 0.5 to 1 SD from mean; C Rows = >1 SD from mean.

With respect to validating the game theoretic model described above, FIG. 7 and FIG. 8 show the utilities of different courses of action for two specific instances of the model (Series 1) plotted on the same graph as the frequency with which human decision makers selected each course of action during the DESSRT simulation (Series 2). As can be seen from the charts, in both of these cases, most participants 16 selected courses of action that tended to be among the highest utility choices, as determined by the model. Similar results were obtained for each of thirteen other instances of the model. While the participants did not necessarily select the model's highest utility courses of action, this should give model designers and users some level of confidence that the game theoretic model is indeed plausibly predicting human behavior in this circumstance. At the same time, it indicates that some refinement of the model might be warranted. The DESSRT tool is thus able to serve a validation function on models with insufficient historical data, which is more convincing than “face validation” alone.

This embodiment demonstrates merely two ways (detailed operational guidance and validation of adaptive adversary models) in which the distributed, empirical, structured and scalable nature of the DESSRT Red Teaming tool, as implemented in the system described above, is capable of extending the efficacy of Red Teaming. A validated CT game theory model 58 and validated adversary tactics model 60 are consequently output from the comparative analysis.

The invention thus includes a computer-implemented method of implementing the steps described herein on a computer, such as virtual machines 12, across network 18. A computer system, such as virtual machines 12, may implement the techniques described herein using custom hardwired logic, one or more ASICs or FPGAs, firmware, and/or program logic that, in conjunction with the computer system, makes a computer system a special-purpose machine or programs computer system, such as virtual machines 12, to be a special-purpose machine. According to one embodiment, the techniques herein are performed by a computer system in response to a processor (virtual or physical) executing one or more sequences of one or more instructions contained in a memory, such as storage 20. Such instructions may be read into main memory from another storage medium, such as storage 20. Execution of the sequences of instructions contained in main memory causes a processor to perform the process steps described herein. In alternative embodiments, hard-wired circuitry may be used in place of or in combination with software instructions.

The term “non-transitory computer readable medium” as used herein refers to any non-transitory medium that stores data and/or instructions for causing a machine to operate in a specific manner. Such storage media may include non-volatile media and/or volatile media. Non-volatile media includes, for example, optical, magnetic disks, or solid-state drives, such as storage 20. Volatile media includes dynamic memory, such as main memory. Common forms of storage media include, for example: a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge. The non-transitory medium can also be accessible across a network 18, or remote physical storage 20.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for conducting enhanced Red Teaming exercises across a network, comprising:
a computer platform configured to provide:
a simulation module that iteratively simulates a specified scenario using predetermined variations in experimental conditions or predefined data, an iterative simulation being sent as a predefined dataset to participants across the network.
a distribution module for providing distributed, generated initial conditions, scenario parameters, background scenario information, debiasing tools and data artifacts to one or more participants across a network;
an input module that provides a user interface for structured data gathering from participant input, the input module provided to one or more participants through the distribution module, the input module further selectively receiving participant data from the network; and
a data generation module for generating empirical results data from the participant data gathered from the input module.

2. The system of claim 1, wherein the distribution module is further configured to provide the simulation dataset for Red Team testing to one or more participants asynchronously.

3. The system of claim 1, wherein the input module further provides at least one standardized input in the user interface.

4. The system of claim 1, wherein the input module further selectively requests further input from the one or more participants.

5. The system of claim 1, wherein the simulation module further selectively alters a number of the one or more participants for the simulation dataset for Red Team testing.

6. A non-transitory computer readable medium that contains instructions that, when executed on a computer platform configure the computer platform to perform the steps of:
iteratively simulating a predefined dataset for red-team testing with predetermined variations in predefined data of the predefined dataset;
providing a distributed, simulation dataset for Red Team testing to one or more participants across a network;
sending the iterative simulation as a predefined dataset to the participants across the network
providing a user interface for structured data gathering from participant input, the user interface providing the simulation dataset to one or more participants;
receiving participant data from the network; and
generating empirical results data from the received participant data.

7. The computer readable medium of claim 6, further configuring the computer platform to provide the simulation dataset for Red Team testing one or more participants asynchronously.

8. The computer readable medium of claim 6, further configuring the computer platform to provide at least one standardized input in the user interface.

9. The computer readable medium of claim 6, further configuring the computer platform to selectively request further input from the one or more participants.

10. The computer readable medium of claim 6, further configuring the computer platform to compare one or more external datasets with the gathered participant data.

11. The computer readable medium of claim 10, further configuring the computer platform to perform the steps of:
comparing the one or more external datasets; and
selectively requesting further input from the one or more participants based upon the one or more external datasets.

12. The computer readable medium of claim 6, further configuring the computer platform to selectively alter a number of the one or more participants for the simulation dataset for Red Team testing.

13. A computer-implemented method for conducting enhanced Red Teaming exercises across a network, comprising:
providing a distributed, predefined dataset for Red Team testing to one or more participants across a network;
providing a user interface for structured data gathering from participant input, the user interface providing the predefined dataset to one or more participants;
receiving participant data from the network;
generating empirical results data from the received participant data;
iteratively simulating the dataset for Red Team testing with predetermined variations in the predefined data; and
sending the iterative simulation as a predefined dataset to the participants across the network.

14. The method of claim 13, further comprising providing the dataset for Red Team testing one or more participants asynchronously.

15. The method of claim 13, further comprising providing at least one standardized input in the user interface.

16. The method of claim 13, further comprising selectively requesting further input from the one or more participants.

17. The method of claim 13, further comprising comparing one or more external datasets with the gathered participant data.

18. The method of claim 13, further comprising selectively altering a number of the one or more participants for the predefined data set for Red Team testing.
